(19) United States
(12) Patent Application Publication
(10) Pub. No.: US 2025/0378457 A1
(43) Pub. Date: Dec. 11, 2025

(54) PRODUCT DISTRIBUTION GROWTH

(71) Applicant: STRIPE, INC., South San Francisco, CA (US)

(72) Inventors: Chaoqun Chen, Bellevue, WA (US); Benjamin Neuwirth, San Francisco, CA (US); Ludwig Steven Wasik, Seattle, WA (US)

(21) Appl. No.: 18/736,061

(22) Filed: Jun. 6, 2024

(51) Int. Cl. G06Q 30/0202; G06Q 10/0637; G06Q 30/0241

(52) U.S. Cl. CPC G06Q 30/0202; G06Q 10/0637; G06Q 30/0247

(57) ABSTRACT

A method includes: computing a feature vector representing a user of a platform, the platform providing access to one or more products among a plurality of available products from a provider; and computing an estimated revenue based on the platform adopting a product of the plurality of available products including: computing a user adoption propensity of the product based on supplying the feature vector to a first machine learning model; computing a usage of the product by the user based on supplying the feature vector to a second machine learning model; computing an overall revenue growth of the user from the one or more products of the platform due to adoption of the product by the user based on supplying the feature vector to a third machine learning model; and computing a retention of the user based on supplying the feature vector to a fourth machine learning model.

### BACKGROUND

Providers of goods and services may distribute products through channel partners, in addition to selling the products directly to consumers. These channel partners may include entities that customize the goods and services for specific target markets or verticals.

The above information disclosed in this Background section is only for enhancement of understanding of the present disclosure, and therefore it may contain information that does not form the prior art that is already known to a person of ordinary skill in the art.

### SUMMARY

The present disclosure is directed to predicting product distribution growth through channel partners, substantially as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram depicting relationships between a provider of goods and/or services, intermediaries or platforms, users of the platforms (e.g., merchants), consumers.

FIG. 2A shows an adoption funnel diagram depicting stages of a user relationship with a product of the provider offered through an intermediary, where the behavior of a customer is as analyzed based on trained statistical models according to one embodiment of the present disclosure.

FIG. 2B is a block diagram depicting relationships between trained machine learning models corresponding to different stages of the adoption funnel according to one embodiment of the present disclosure.

FIG. 2C is a depiction of the calculation of overall estimated revenue for two example platforms with two users, according to one embodiment of the present disclosure.

FIG. 3A is a block diagram depicting components of a system for predicting the propensity of a customer or prospective customer to adopt services offered by a platform according to one embodiment of the present disclosure.

FIG. 3B is a flowchart depicting a method for predicting the propensity of a customer or prospective customer to adopt services offered by a platform according to one embodiment of the present disclosure.

FIG. 3C is a flowchart depicting a method for training a system to predict the propensity of a customer or prospective customer to adopt services offered by a platform according to one embodiment of the present disclosure.

FIG. 4 is a flowchart of a method for training machine learning models corresponding to different stages of the adoption funnel, according to one embodiment of the present disclosure.

FIG. 5A is a flowchart of a method for generating a ranking of products to be adopted by a platform using trained statistical models corresponding to different stages of the adoption funnel, according to one embodiment of the present disclosure.

FIG. 5B is a flowchart of a method for computing per-product revenue estimates based on different stages of the adoption funnel, according to one embodiment of the present disclosure.

FIG. 5C is a flowchart of a method for computing an estimated revenue increase using trained statistical models corresponding to different stages of the adoption funnel, according to one embodiment of the present disclosure.

FIG. 6 is a block diagram illustrating a high-level network architecture of a computing system environment for operating a processing system according to embodiments of the present disclosure.

FIG. 7 is a block diagram illustrating a representative software architecture, which may be used in conjunction with various hardware architectures as described herein.

FIG. 8 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

A provider of goods and/or services products may choose to distribute those products to users or customers through intermediaries, referred to in some contexts as channel partners or platforms. In some circumstances, the intermediaries customize the products for a target market or industry vertical, such as by selecting a subset of those products and integrating the products into a system that is customized for those end users.

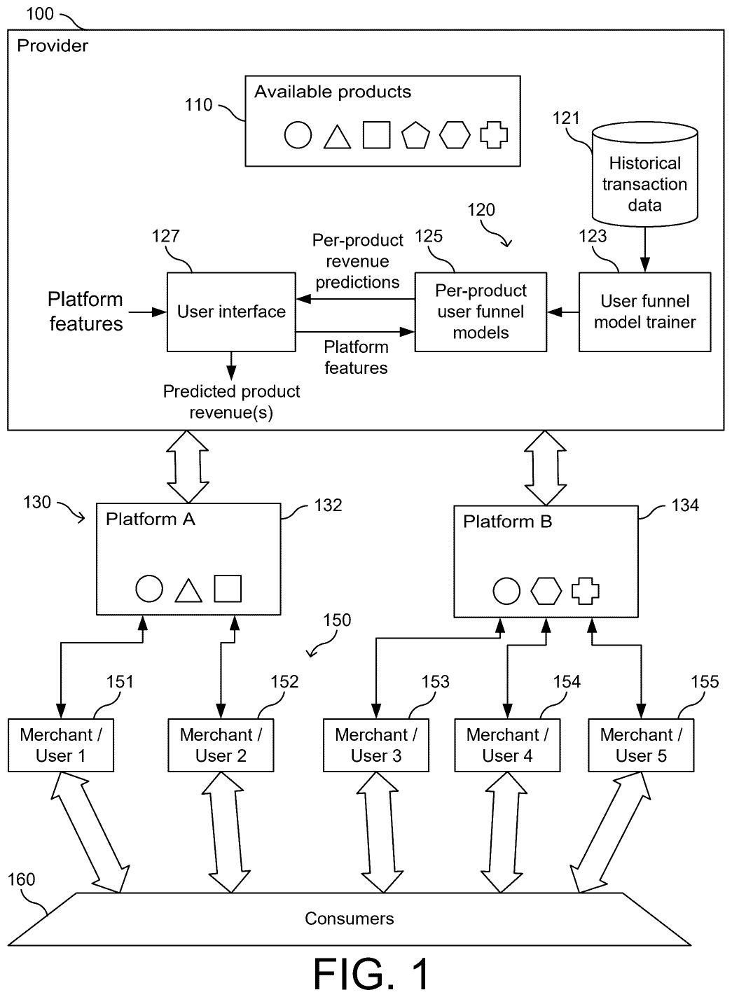

FIG. 1 is a block diagram depicting relationships between a provider 100 of goods and/or services, intermediaries or platforms, users of the platforms (e.g., merchants), consumers. In the diagram of FIG. 1, a provider 100 has a collection of available products 110 that can be adopted by various platforms 130, shown as a first platform 132 (Platform A) and a second platform 134 (Platform B). These intermediaries or platforms 130 have users 150, which may be merchants (e.g., businesses and/or independent agents) who interact with consumers 160.

As one example, a provider of financial services may offer products such as payment processing (e.g., for accepting payment by credit card, debit card, electronic payment platforms, and the like), physical point-of-sale devices (e.g., credit card readers), advance payment arrangements (e.g., cash advance loans), tax computation (e.g., for compliance with local sales taxes, value added taxes, and goods and services taxes, which may differ between the various jurisdictions in which a merchant does business), fraud detection services, and the like. While a subset of those products may be applicable to a given user, other products may be irrelevant to that user.

An intermediary or platform targeting a particular market (e.g., users 150 who are independent food delivery contractors) may select services from among the available products 110 that are most applicable to that market, create a software platform that integrates the selected services, and provides its end users (e.g., the delivery drivers) with a streamlined user interface to operate their businesses (e.g., accepting payments from people accepting food deliveries and receiving cash advances of payments) while leaving out services that may be inapplicable or that have limited benefit (e.g., fraud detection). Another platform targeting a different market (e.g., a platform providing an electronic storefront for online retail sale of homemade crafts and similar goods) may choose a different set of products among the available products 110 (e.g., online payment, fraud detection, inventory management, and the like). Intermediaries may also offer some of the products as optional add-ons (e.g., a user may utilize the cash advance product to receive their compensation immediately at the expense of a transaction fee or may choose to wait for the standard payout period and receive the full amount).

As shown in FIG. 1, the first platform 132 and the second platform 134 have adopted different products among the available products 110, where the different products are represented generally by different geometric shapes (e.g., circle, triangle, square, pentagon, hexagon, and cross shapes). The first platform 132 (Platform A) is shown in FIG. 1 as interacting with a first user 151 (Merchant/User 1) and a second user 152 (Merchant/User 2). The second platform 134 (Platform B) is shown in FIG. 1 as interacting with a third user 153 (Merchant/User 3), a fourth user 154 (Merchant/User 4), and a fifth user 155 (Merchant/User 5). In general, platforms 130 will have hundreds or thousands of users. The individual users 150 interact with consumers 160, where products supplied from the provider 100 through the platforms 130 assist or facilitate the interactions between the users 150 (merchants) and consumers 160. As noted above, these products offered by the provider 100 may relate to facilitating accepting payments from consumers 160, offering financing to consumers 160 (e.g., buy-now-pay-later), fraud detection services (e.g., to automatically detect fraudulent activity by a consumer 160 and/or by a user 150), sales tax accounting services, and the like. However, embodiments of the present disclosure are not limited thereto and other types of products of providers may be adopted by platforms 130 and offered to users 150, such as website hosting services, accounting services, white label products, custom manufacturing services, and the like.

A platform (or intermediary or marketplace) 130 may be compensated for selling the products to its users 150 based on arrangements such as the number of users 150 using each product or as a percentage of the value of the payments processed through the services (e.g., as a percentage of revenue). Accordingly, platforms 130 may be incentivized to sell more products to its users.

Different types of intermediaries or platforms 130 support different types of users 150. As noted above, one type of intermediary may target freelance workers (e.g., individuals operating in the gig economy), where these freelance workers may perform services mediated by the intermediary (e.g., drivers performing rideshare services and food delivery services, artists creating custom artwork for users, and the like), where the intermediary may match workers with consumers (e.g., taking restaurant orders and dispatching freelance workers to pick up and deliver the orders to consumers). Another type of intermediary may provide online marketplaces for vendors to sell products, such as handmade items (e.g., jewelry, baggage, clothing, home décor, furniture, toys, art, tools, and the like), used books and tools, and the like. Still another type of intermediary may provide a back-end solution for operating a specific type of business, such as a hair salon or a pizzeria, where the provided system is customized to the needs of that business type (e.g., integrating reservation systems for hair salons, whereas a system for managing a pizzeria may include systems for managing inventory, ordering from vendors, and tracking orders).

Due to differences in the markets associated with these different intermediaries (e.g., online sales of physical goods versus sales of digital goods versus in-person sales of perishable products, and the like) mean that different types of products may have different levels of adoption among users (or customers) of different platforms. For example, delivery drivers may have a need to take payments using a physical credit card reader, but this product would be useless to an online-only retailer. As another example, different types of users may experience different types of fraud, and where the fraud detection tools offered by the provider 100 may only be applicable to certain types of fraud.

Platforms 130 may lack insight into which of its users are most likely to make use of the products offered by the provider 100. This affects both the choice of which products to market to its users (e.g., promoting the use of the cash advance product within the user interface presented to its delivery drivers) as well as the choice of which products from the provider to integrate to begin with (e.g., whether the revenue increase will pay for the engineering expense to integrate the product). This problem of choosing from a large number of available products 110 arises, in part, when providers of software-as-a-service products offer a large range of products to customers who are free to mix and match these products as they choose to fit their needs. However, given the wide range of users who engage with the platform and the combinatorically large number of ways to choose products, it is difficult for users to understand how the various products may benefit them.

Accordingly, aspects of embodiments of the present disclosure relate to computing, automatically, the likelihood that individual users of an intermediary or platform will use various products offered by the provider. Some aspects of embodiments of the present disclosure similarly relate to computing, automatically, an expected revenue from a customer of the intermediary from using a particular product offered by the provider. These computations provide intermediaries with the expected revenue from selling these products to its users, as customized based on characteristics of those users.

In some embodiments of the present disclosure, a user interface generates a report that includes the expected revenue values of different products, as customized for an intermediary based on its users. In some embodiments, the products are ranked or ordered based on expected revenue, thereby providing guidance as to which products would be most valuable (e.g., profitable) to integrate and/or promote to users. In some embodiments, the report is displayed to a sales representative of the provider, for use in discussions with an intermediary. In some embodiments, the report is displayed to a representative of the intermediary (e.g., on a web page operated by the provider and customized for the intermediary).

As will be described in more detail below, a product revenue estimator 120 according to some embodiments of the present disclosure automatically generates estimates of revenue changes after a platform adopts one or more of the available products 110. These estimates are computed automatically based on trained machine learning models that are trained based on historical transaction data 121 of transactions processed by the provider 100 in association with the available products 110, including historical transaction before and after adoption of various ones of the available products 110 by other platforms.

In some embodiments, the estimates are computed based on a per-product user funnel model, corresponding the progression of platforms (or intermediaries) and their users (or connected accounts) through various stages of an adoption funnel and eventually produce revenue through adoption and use of the products.

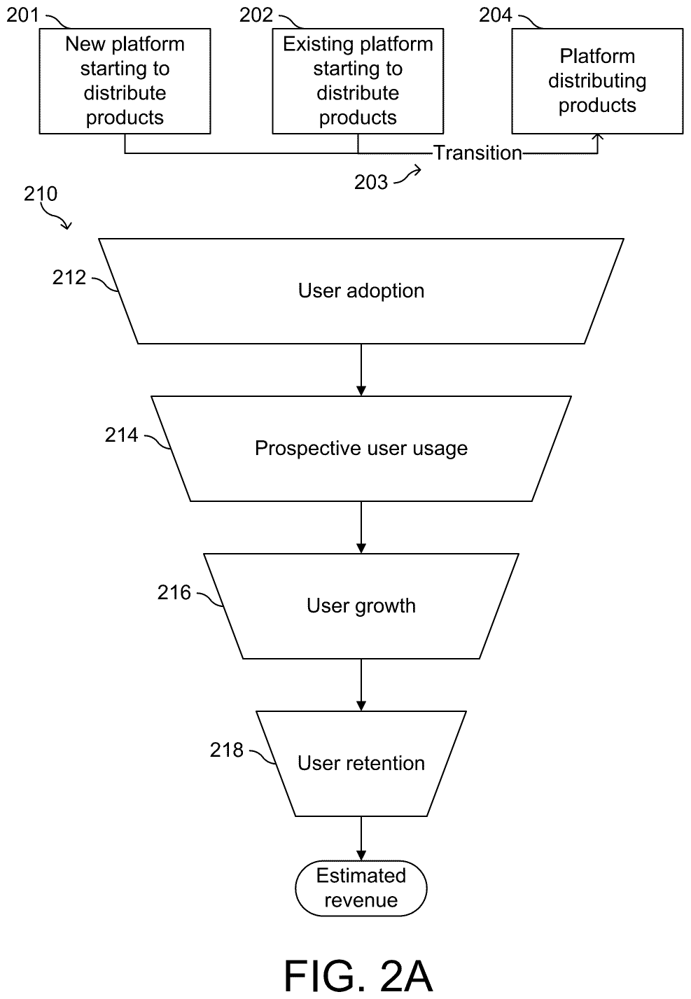

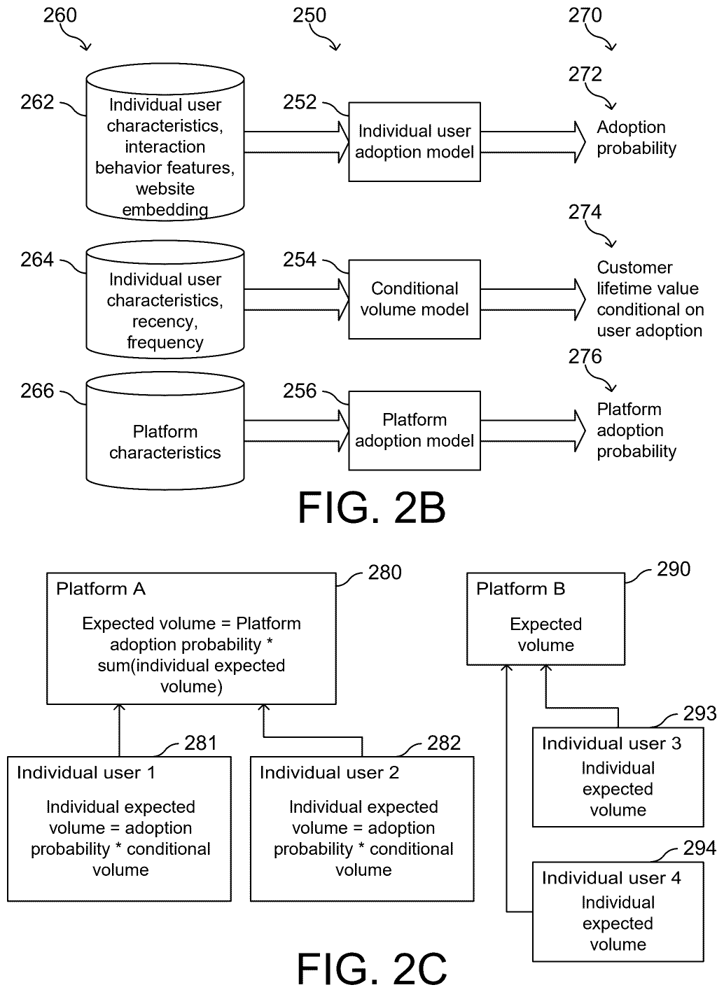

FIG. 2A shows an adoption funnel diagram depicting stages of a user relationship with a product of the provider offered through an intermediary, where the behavior of a customer is as analyzed based on trained statistical models according to one embodiment of the present disclosure. As shown in FIG. 2A, a new platform 201 may start to distribute products of the provider to its users and, similarly, an existing platform 202 may choose to offer one or more additional products of the provider to its users. In either case, there will be a transition period 203 where usage of the products will grow as some or all users of the platform choose to adopt the products when interacting with their customers (e.g., consumers). The revenue growth to the platform and to the provider of the products depends on the extent to which the users of the platform adopt these products and make use of these products in their businesses. The rate at which users adopt these products, use these products, grow over time, and continue using these products (user retention) generally follows different patterns depending on features of the platforms (e.g., platform categories).

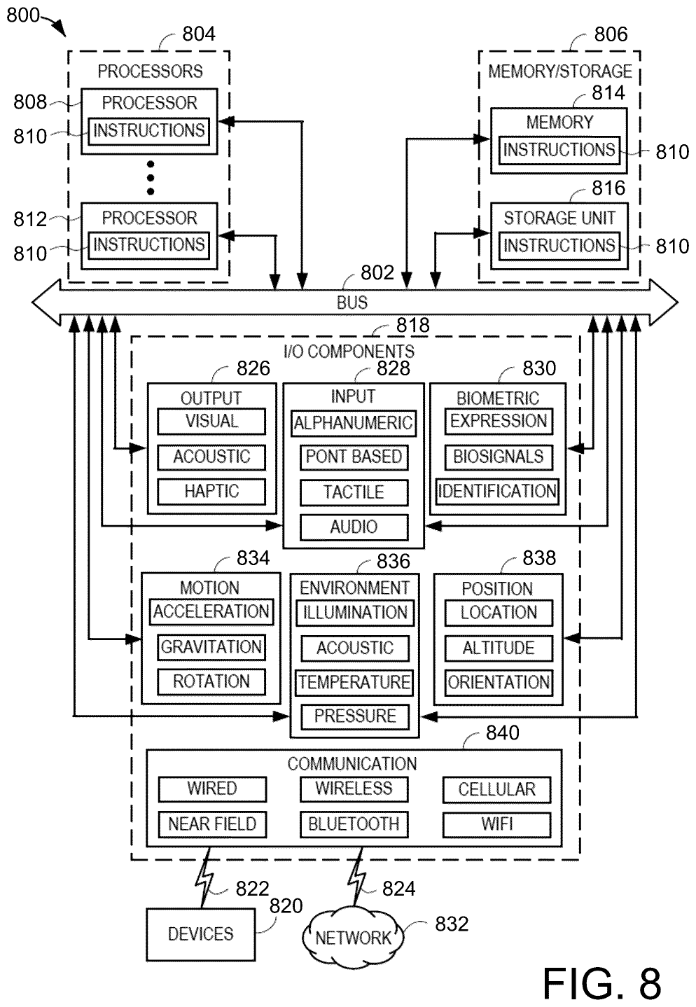

Accordingly, a user product adoption funnel 210 of FIG. 2A includes multiple stages that model the revenue growth of a platform in response to adoption of a product and after completing the transition period 203 (a transition period of time). In various embodiments of the present disclosure, a separate machine learning model is trained to estimate the outputs of each stage of the funnel, as described in more detail below. The intermediate outputs of stages of the funnel may be referred to herein as usage factors or product usage factors. In some embodiments, the separate machine models are implemented using a computer system, such as the computer system 800 described below with respect to FIG. 8. FIG. 2B is a block diagram depicting relationships between trained machine learning models 250 corresponding to different stages of the user product adoption funnel 210, where the machine learning models 250 are trained based on different training data 260 to compute usage factors 270 according to one embodiment of the present disclosure.

A user adoption stage 212 of the user product adoption funnel 210 relates to the adoption of the product offered by the platform by its users as one of the usage factors. While a platform provider may offer such a product to its users, users may choose whether to adopt such a product. For example, a platform that provides hair salon management services may choose to offer a product, such as buy-now-pay-later financing for consumers (e.g., patrons of the hair salon), such that those consumers can spread the payments for the hair styling over time. Any given hair salon who is a user of the platform may choose whether to adopt this product (e.g., weighing the potential growth in access to customers against concerns about credit risk, social concerns about the appearance of offering financing, and the like).

In some embodiments, an individual user adoption machine learning model 252 is trained based on corresponding training data 262 (such as individual user characteristics, interaction behavior features, website embedding, and the like) to compute an adoption probability or propensity 272 that users of the platform (as described based on one or more features of the platform, described in more detail below) will adopt a specific product (e.g., a buy-now-pay-later product, a point-of-sale payment product, a cash advance product, or the like) during the transition period 203 (e.g., compute a user adoption propensity for the product). In some embodiments, the transition period 203 may be set as a period of time in accordance with observations about the adoption rate of products (e.g., historical data may show that adoption of a new product among existing users levels off 6 months after introduction, or that marketing specific products to users may increase adoption over the period in which the marketing messages are sent). The platform may be described based on various features (e.g., geographic region, industry category, transaction history such as average sale size, and the like), as will be described in more detail below. This probability may then be used to compute an expected number of users of the product (e.g., multiplying the number of users of the platform by the probability that the users of the platform will adopt the product) after completing the transition period 203.

A prospective user usage stage 214 of the user product adoption funnel 210 is conditional on user adoption at 212 as one of the usage factors. In other words, only users who adopted the product at the user adoption stage 212 will be using that product. Among these users of the product, various users may exhibit a range of usage levels of those products. For example, different hair salons may have different volume levels or different business models (e.g., single hair stylists versus a group of multiple hair stylists working together, different ranges of services or ancillary services such as sales of cosmetics and hair care products). Accordingly, in some embodiments of the present disclosure, a user usage machine learning model or conditional volume model 254 is trained to compute a predicted revenue from the product (e.g., revenue from buy-now-pay-later transactions) among the users of the platform who adopted the product or customer lifetime value (CLV) conditional on user adoption 274 based on training data 264 (e.g., individual user characteristics, recency, frequency, and the like).

A prospective user growth stage 216 of the user product adoption funnel 210 relates to overall revenue growth of the user, not limited to the specific product that was adopted by the user, but including revenue from other products that were adopted by the user (e.g., physical point-of-sale devices, fraud detection products, cash advance products, short term loans, and the like) as one of the usage factors. Adopting the specific product may also increase the usage of other products that were already adopted by the user. For example, adopting a buy-now-pay-later product may increase the conversion rate and result in more transactions being completed with consumers, which increases the usage of other products (such as sales tax computation and fraud detection) and thereby increases the overall growth of revenue associated with the user, attendant with the growth in revenue of the user itself due to the additional transactions.

In some embodiments, these predicted revenues in both the prospective user usage stage 214 and the user growth stage 216 of the user product adoption funnel 210 are computed based on specific characteristics of the individual users of the platform, such as visits to or usage of user interfaces (e.g., websites) associated with the provider. In some embodiments, these predicted revenues are computed based on statistical information regarding the users of the platform (e.g., distributions of revenue among the users, industry of the platform, and the like).

A user retention stage 218 of the user product adoption funnel 210 relates to determining the user will continue to be a customer of the platform at the end of the transition period 203 as one of the usage factors. Users may stop using a platform for various reasons, such as switching to a different platform, switching to a different business (or retirement), replacing the services provided by the platform with standalone solutions, consolidation with another business, and the like. As such, some portion of the users of the platform at the beginning of the transition period 203 may no longer be users at the end of the transition period 203. In some embodiments, a machine learning model is trained, based on historical behavior of users of the platform, to compute predictions of user retention rates. In some embodiments, the user retention rates are computed as part of a buy-till-you-die model, described in more detail below.

In some embodiments of the present disclosure, the user usage model, the user growth model, and the user retention model are modeled using a buy-till-you-die (BTYD) model, as modified to take input features representing prospective users (or prospective customers) rather than current users (or current customers), in order to generate prospective user usage, prospective user growth, and prospective user retention (or term). In some embodiments of the present disclosure, a gradient boosted trees model (e.g., XGBoost model) is used in the BTYD model to estimate a monetary value (e.g., spending per period).

When considering the product adoption funnel for platforms that have not yet started distributing a particular product, the product adoption funnel may include an additional platform adoption stage before the user adoption stage 212. The platform adoption stage relates to a prerequisite that the platform chooses to offer the particular product to its users. In some embodiments, a platform adoption machine learning model 256 is trained to compute the probability that a given platform will adopt a particular product and offer that product to its users, based on various features of the platform, or a platform adoption probability 276, based on training data 266 such as the characteristics of the platform.

The features describing a platform, which may be used as features for any of the machine learning models described herein include, but are not limited to: industry category; geographic region (e.g., country, state or province, continent, and the like); transaction history (e.g., sales volume, average sale size, in-person payments versus online payments, subscription services, and the like); and demand from users (e.g., as measured by, for example, visits from known users of the platform to product pages of the website of the provider of those products to the platform and interactions between users of the platform and user interfaces exposed by the provider through the platform).

In some embodiments, the computer system calculates an overall estimated revenue 290 for a given combination of a platform and a product in accordance with the following equation, where i is an index of a user, j is an index of a product among a plurality of products offered by the provider, and t is a time index:

$$Product j revenue over period = P ( PlatformActivation ) * {\sum }_{i , t} P ( {ProductAlive}_{ijt} ) * P ( {Adoption}_{ijt} ) * {ProductPIV}_{ijt} * {ProductMargin}_{ijt}$$

where P(*) denotes probability and P(PlatformActivation)=1 if a platform is already distributing product j. P(PlatformActivation) is the probability that the platform will adopt the product, P(ProductAliveᵢⱼₜ) is the probability that the user i is still on the platform at time t, P(Adoptionᵢⱼₜ) is the probability that user i will adopt product j by time t (this may have a value of 1 if user i has already adopted the product). ProductPIVᵢⱼₜ is the predicted revenue from product j contributed by user i at time t. ProductMarginᵢⱼₜ is a model to calculate platform-level margin for each product. In some embodiments, the ProductMarginᵢⱼₜ is omitted, depending on which final metric is to be calculated. For example, in a case where product volume is the metric of interest, then the platform-level margin may be omitted.

FIG. 2C is a depiction of the calculation of overall estimated revenue for two example platforms with two users, according to one embodiment of the present disclosure. In the example of FIG. 2C, Platform A 280 is a prospective platform that has not yet adopted a given product. As such, the expected volume from Platform A 280 is the platform adoption probability 276 multiplied by the sum of the individual expected volumes of the users of the platform. In FIG. 2C, Platform A 280 is shown as having two individual users (in practice, Platform A may have thousands or more individual users). A first individual user 281 and a second individual user 282 may not yet have adopted the product either and therefore the expected individual volumes are the probability that each individual user 281 and 282 will adopt the product (adoption probability 272) multiplied by the conditional volume from that user (customer lifetime value conditional on user adoption 274). Similarly, the expected volume for platform B 290 would be calculated independently based on its corresponding platform adoption probability 276 and the individual expected volume of its users (e.g., including third individual user 293 and fourth individual user 294), as calculated based on their adoption probabilities 272 and conditional volumes 274.

In addition, some aspects of embodiments relate to calculating the incremental revenue indirectly impacted by product adoption through user growth and retention:

$$Overall reveue over period = {\sum }_{i , t} P ( {Alive}_{it} ) * {OverallPIV}_{it} * {OverallMargin}_{ijt}$$

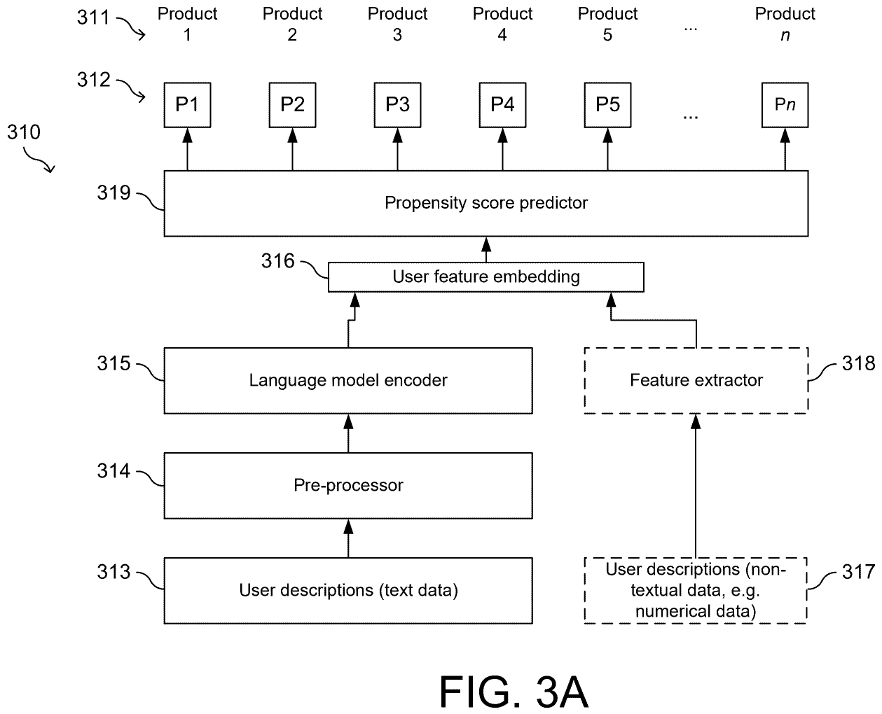

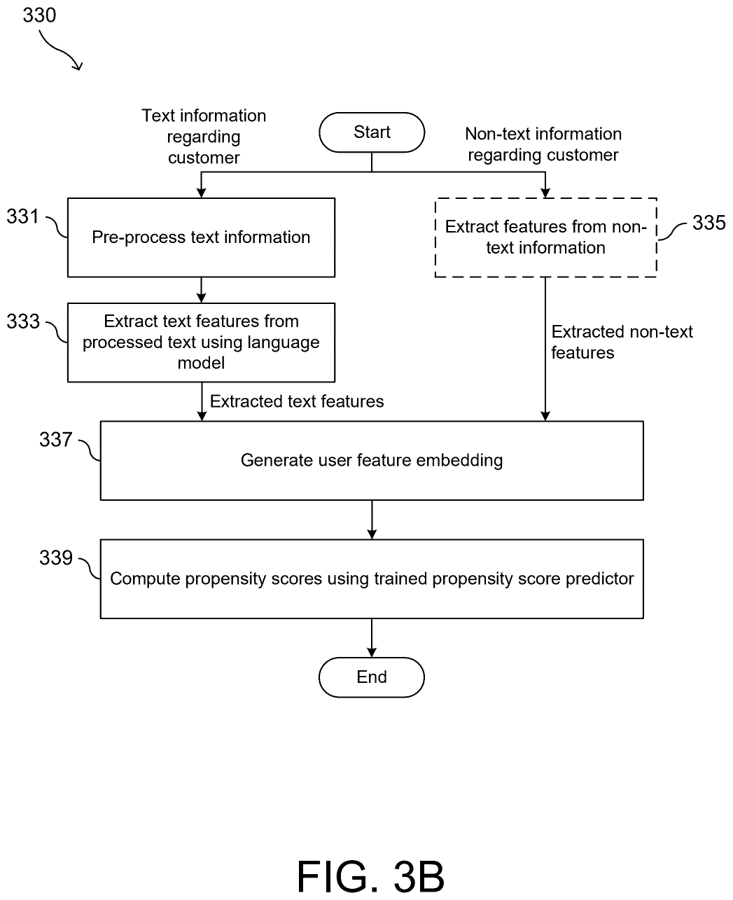

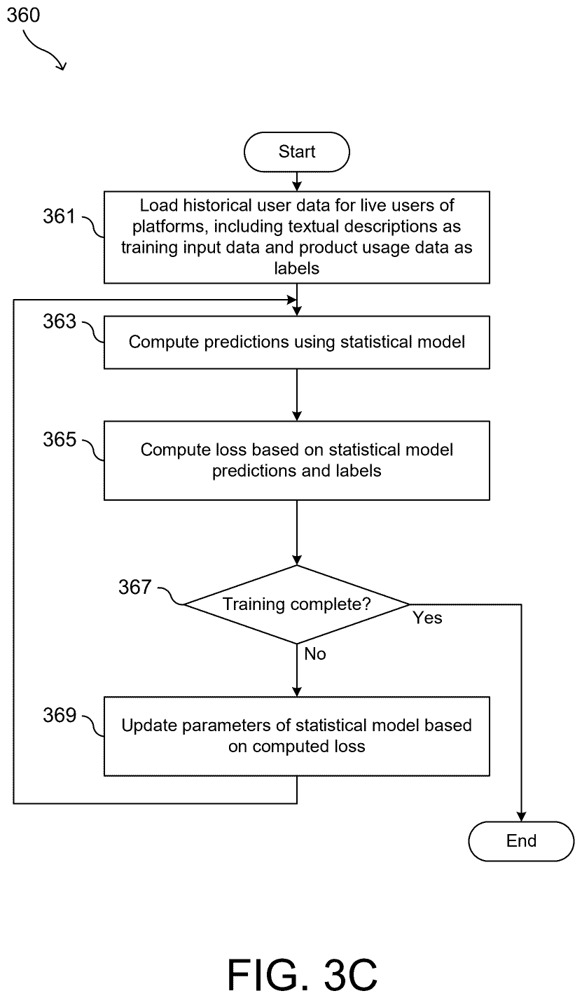

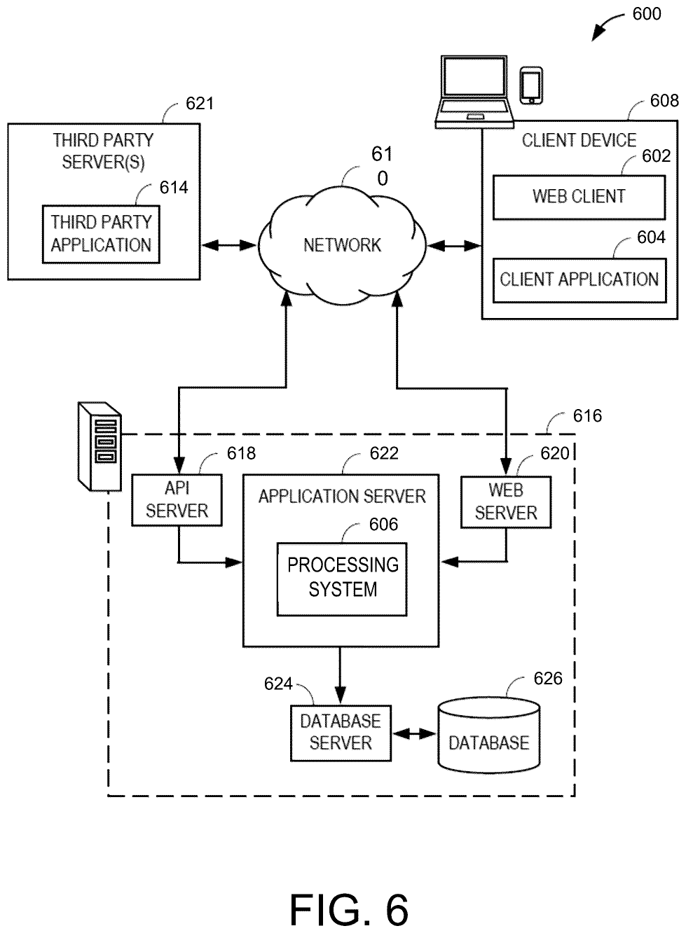

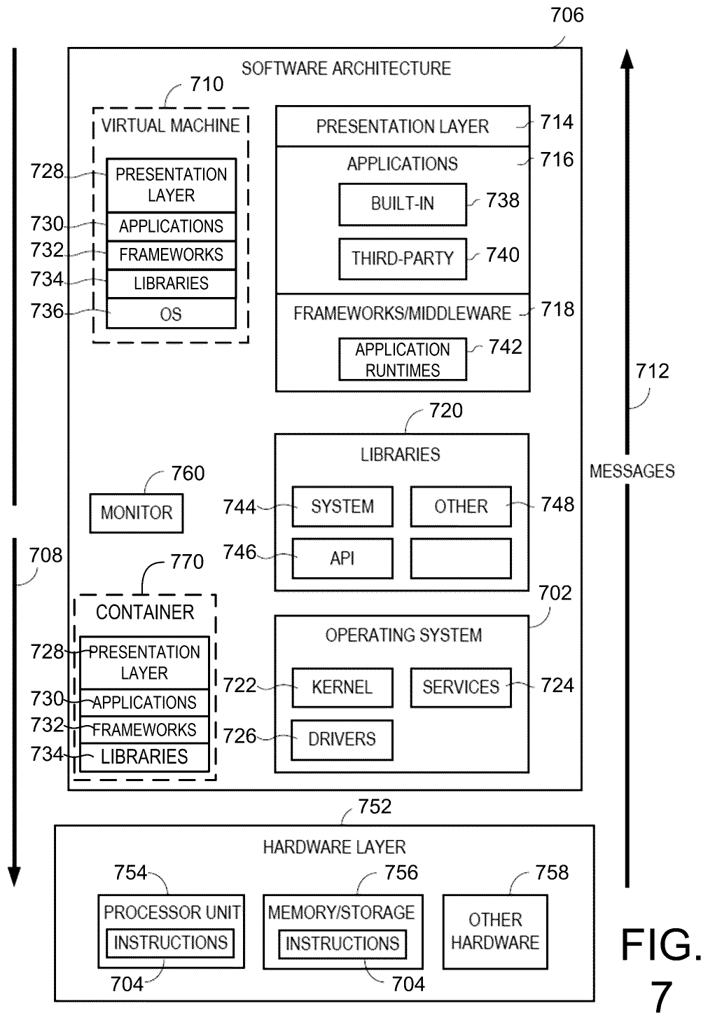

FIG. 3A is a block diagram depicting components of a system 310 for predicting the propensity of a user or prospective user 150 (e.g., a prospective merchant) to adopt a product offered by a platform 130 according to one embodiment of the present disclosure. The system 310 may be implemented using one or more computing devices, examples of which are described in more detail below with respect to FIGS. 6-8. For example, the input data, intermediate data, and output data (e.g., predictions) computed by the system 310 may be stored in one or more memory circuits of one or more computing devices, where the intermediate results and the output predictions may be computed based on the data input are computed using one or more processing circuits of the one or more computing devices. These processing circuits may include, but are not limited to, central processing units (CPUs), graphics processing units (GPUs), neural accelerator units, field programmable gate arrays (FPGAs), application specific integrated circuits (ASICs), and the like. The processing circuits are configured to perform operations according to various embodiments of the present disclosure using program instructions that may be stored in one or more memory circuits (e.g., the same memory circuits that store the input data, output data, and intermediate results, or different memory circuits).

As shown in FIG. 3A, the system may be configured to predict the propensity of a user (e.g., prospective user or a newly onboarded user) to adopt each of a plurality of different products 311, illustrated in FIG. 3A as Product 1 through Product n. Each of the products 311 may relate to a different service or product among the available products 110 offered by the provider 100. For example, in the case of a financial services provider, these may include a product for a user to manage subscriptions to services that are provided by the user 150 to consumers 160, a product for managing the computation, collection, and payment of sales taxes across different jurisdictions, and a product for managing the issuance of credit cards. As another example, in the case of cloud computing services provider, these may include a web app hosting service, a virtual machine service, a database service, a key value store service, a block storage device service, an infrastructure health monitoring service, an alert service, a message queue service, and the like.

As noted above, the system 310 is configured to compute, for the users, a plurality of propensities 312 corresponding to each of the products 311. Each of the propensities 312 represents a degree of product fit between the product and the users (e.g., a likelihood, probability, or other numerical metric). These propensities 312 may therefore be used to evaluate the likelihood that the users of the platform will adopt the corresponding product (e.g., become a subscriber or user of that corresponding product).

FIG. 3B is a flowchart depicting a method 330 for predicting the propensity of a user (or merchant) to adopt services from a provider 100 as offered by an intermediary platform 130 according to one embodiment of the present disclosure. The inputs to the system 310 include user descriptions that is available for those users. These user descriptions may include text data 313 and non-textual data (e.g., numerical data) 317.

In some cases, where a platform 130 has existing users, the platform may have detailed information about those users (e.g., in the case of a platform that provides online retail storefronts for its users, the platform may have information about those users, such as the types of goods sold or industry, the average cart size for each of those users, the average monthly volume of sales, and the like). In such cases, features may be extracted from the known information about these customers to make per-user predictions as to the likelihood that those users will make use of a given product of the available products 110 offered by the provider 100.

In other cases, a platform 130 may have relatively little detailed information about its users and prospective users. In some embodiments of the present disclosure, the inputs to the system 310 include characteristics of typical users or expected users. These characteristics may be based on information about the platform, such as the target geographic region or regions that the platform operates in, the industry serviced by the platform (e.g., restaurants, food deliveries, household goods, and the like), and the type of market (e.g., online retail sales, online action sales, in-person or brick-and-mortal retail goods, eat-in versus delivery restaurants, and the like), and other properties of the users such as whether their sales are primarily to end-user consumers versus other businesses (notwithstanding these other businesses being labeled “consumers 150” in FIG. 1). These features describing the users (or merchants) may be supplied directly in place of the user descriptions 313 and 317 shown in FIG. 3A or may be used to generate corresponding user descriptions 313 and 317.

The available text-based data 313 regarding users to be evaluated for propensity to adopt various product may be collected together and supplied to a pre-processor 314. At 331, the pre-processor applies transformations to the text data using natural language processing (NLP) techniques, such as removing stop words (e.g., words with low semantic value such as “the”, “and”, “a”, “at”, “which”, “that”, “on”, and the like), computing the length of the collected text, removing duplicate chunks of text, and the like.

At 333, the pre-processed text is then provided to a language model encoder 315, which is configured to generate a customer feature embedding 316 (or feature vector) of the pre-processed text (e.g., a representation of the text as a vector of numbers) in an embedding space (e.g., or latent space or latent feature space, where similar customers have similar customer feature embeddings). Examples of language models that may be used to perform the embedding of the text into a latent space include, but are not limited to, Bidirectional Encoder Representations from Transformers (BERT), generative pre-trained transformers (GPT), and the like. The language models may be pre-trained or fine-tuned based on the types of text data expected to be presented to the language model encoder 315 (e.g., text descriptions of the types of companies that are expected to be customers of the service provider).

As noted above, in some circumstances the system may have access to non-textual data 317 regarding the user, such as numerical data. These non-textual data 317 may include data collected from public information provided by the user (e.g., on a website), from third-party data sources, from public sources, and the like, and may also include data collected directly from the user during sign-up with the platform. In a case where the propensity of prospective users is evaluated, characteristics of the platform and its associated target market of users are used to identify non-textual data regarding the typical or expected user of the platform. These non-textual data may be identified, for example, based on data from the historical transaction data 121, such as by identifying a platform or platforms that are most similar to the current platform and identifying the non-textual data of users of other platforms (e.g., statistical distribution of such non-textual data of these users of the other platforms). At 335, in a case where such non-textual data is available, the system 310 extracts features from this information (e.g., using feature extractor 318).

In some embodiments, the feature extractor 318 converts data into a format suitable for inclusion in the user feature embedding 316 (or feature vector). These conversions may include, for example, normalizing input data values into specified ranges and/or applying mathematical operations to the input data values (e.g., converting input values such as revenue or company size to a normalized log scale ranging from 0 to 1), converting multiple choice responses to a one-hot encoding.

At 337, the system 310 generates the user feature embedding 316. In circumstances where such non-textual data 317 regarding the user is available, the extracted features from the non-textual data 317 are combined with the extracted text features (e.g., as extracted using the language model). In circumstances where no non-textual data 317 is available (e.g., only text data is available), then, in some embodiments, the system 310 inserts default values for portions of the user feature embedding that correspond to the non-text features.

At 339, the system 310 supplies the user feature embedding to a propensity score predictor 319, where the propensity score predictor 319 is trained to compute the plurality of propensities 312 for users of the platform to adopt each of the products 311. In some embodiments, the propensity score predictor 319 is implemented using a neural network. For example, the propensity score predictor 319 may include one or more fully connected layers (FC layers) of a neural network (e.g., a neural network with a single hidden layer or a deep neural network having more than one hidden layer, where one or more of the hidden layers are fully connected layers). In various embodiments, the propensity score predictor 319 may be implemented using other trained models such as a gradient boosting with a forest of decision trees (e.g., using XGBoost).

FIG. 3C is a flowchart depicting a method 360 for training a propensity score predictor to predict the propensity of a user or prospective user to adopt services offered by a platform according to one embodiment of the present disclosure. In some embodiments, the method shown in FIG. 3C is performed by the model trainer 123 as shown in FIG. 1A, where the model trainer 123 is implemented using one or more processing circuits executing instructions stored in one or more memory circuits, where the instructions configure the processing circuits to perform as special purpose devices to perform operations according to embodiments of the present disclosure.

As shown in FIG. 3C, at 361 the model trainer 123 loads historical user data for live users (and/or previously live users) from the historical transaction data 121 as a training data set. This user data includes information corresponding to the inputs that are to be supplied to the model (e.g., textual data collected from scraping customer websites, from third parties, from published information, and from user responses to questions during a sign-up process completed with their corresponding platforms). In addition, the historical transaction data 121 may store product usage data for products offered by the service provider since signing up with the service (e.g., which products were adopted and actively used by the customer over a time period, such as being adopted within the first 30 days or first 90 days as a live user of the platform). These product usage data serve as labels for the training data. Accordingly, using a method such as the method shown in FIG. 3C, the model trainer 123 trains a statistical model (e.g., a neural network or a fully connected layer thereof, a gradient boosting model, or the like) to predict the labels (e.g., the products) that will be adopted by a user of a platform based on these input data.

In more detail, an initial statistical model may be provided as an additional input to the model trainer 123, where the statistical model may have its parameters (e.g., weights of connections between neurons in a case where the statistical model is a neural network) set to random values (e.g., set using a random number generator) or may have pre-trained parameters that were trained on another data set (e.g., older historical customer data or trained for a different collection of products). At 363, the model trainer 123 computes predictions using the statistical model (e.g., using its current set of parameters). These predictions may correspond to scores representing propensities for a given customer to use or adopt the various products. At 365, the model trainer 123 compares the computed predictions (the outputs of the statistical model) to the labels (e.g., the actual products used by the customers in the training data set) using a loss function to compute loss values.

At 367, the model trainer 123 determines whether the model training process for the statistical model is complete. In some circumstances, this is determined based on whether the accuracy of the statistical model is no longer improving over the previous version of the statistical model based on the previous parameters (e.g., the training of the statistical model has converged), or has improved by less than some threshold amount. In some circumstances, this is determined based on reaching some desired level of accuracy. In some embodiments, this is determined based on reaching a maximum number of training iterations. In some embodiments, this is determined based on a combination of the factors discussed above and may include additional factors.

In a case where training is not complete, at 369 the model trainer 123 updates the parameters of the statistical model based on the computed loss. In some embodiments, this is performed using gradient descent and, in the case of a neural network, the parameters of the neural network (the weights of the connections between the layers of neurons) are updated using backpropagation. After updating the parameters of the statistical model, the model trainer 123 returns to perform another iteration of the training process at 363. Different iterations of the training process may use different portions of the training data (e.g., the training data may be broken into batches).

In a case where the model training is determined to be complete, then the trained model (e.g., the trained parameters) are output by the model trainer 123, and the trained model may be included in the trained per-product user funnel models 125 shown in FIG. 1 (e.g., after validating the model using validation data taken from the historical transaction data 121).

Accordingly, FIG. 3A, FIG. 3B, and FIG. 3C depict some embodiments of methods for training and implementing statistical models to compute the propensity of a prospective customer or a newly onboarded customer to adopt various products offered by a service provider based on training data from the product adoption behavior of other customers of the service provider.

Some aspects of embodiments of the present disclosure relate to further updating the system 310 to compute propensity scores for additional products (e.g., newly added products) or to remove products (e.g., remove discontinued products). For example, in the architecture shown in FIG. 3A, components such as the customer descriptions in the form of available text-based data 313, the pre-processor 314, the language model encoder 315, and the feature extractor 318 are not affected by the addition or removal of products. Instead, the addition or removal of products merely involves changing the behavior of the propensity score predictor. Accordingly, in a case where the propensity score predictor 319 is implemented using a neural network (e.g., a neural network having a single, fully connected hidden layer or a deep neural network having multiple hidden layers), changes in the collection of products for which the system 310 will generate recommendations involves re-training the propensity score predictor 319, such as by applying the method 360 shown in FIG. 3C, where the starting point of the statistical model may be the pre-trained weights of the prior model (updated to change the number of outputs or to change the mapping of the outputs to propensities for corresponding products).

In some embodiments of the present disclosure, the statistical model includes a separate, independent statistical model for each product. Accordingly, removing a product from the system (e.g., when a product is discontinued) may be performed by removing the corresponding model for that product from the statistical model (without affecting the computations of propensities for the other products) and adding a product to the system (e.g., when a new product is introduced) may be performed by training a new statistical model for that product (without affecting the computations of the propensities for the other products).

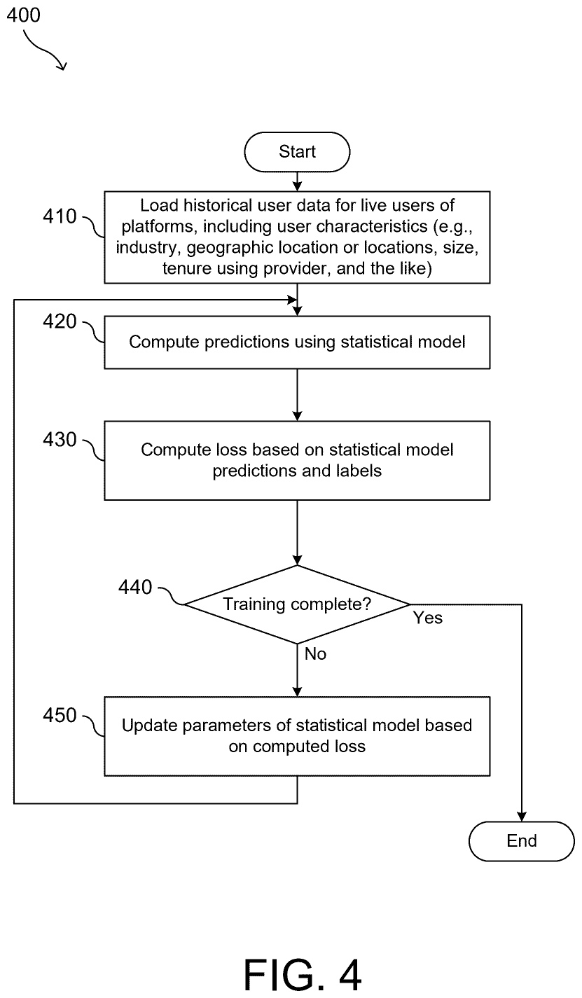

FIG. 4 is a flowchart of a method 400 for training machine learning models corresponding to different stages of the user product adoption funnel 210, according to one embodiment of the present disclosure. In some embodiments, the training data includes the existing users of a given product, and their usage frequency, recency, and monetary value (e.g., volume per period). As noted above, in some embodiments, the model is a buy-till-you-die (BTYD) model, such as a beta-geometric negative binomial distribution (BG-NBD) model and may include a model for computing monetary value, such as a gradient boosted trees model (e.g., XGBoost model). The BG-NBD model may be modeled as a function of user characteristics (e.g., industry, geographic location such as country, number of user employees, user total revenue, and the like) to capture user differences. The features of the gradient boosted trees model may include user industry, country, company size, tenure with the provider, and the like. In some embodiments of the present disclosure, the user usage model, the user growth model, and the user retention model are modeled using different aspects of a same BTYD model (e.g., where the user usage, user growth, and user retention are different outputs of a same trained model).

As shown in FIG. 4, at 410, the model trainer 123 loads historical user data for live users (and/or previously live users) from the historical transaction data 121 as a training data set. This user data includes information corresponding to the inputs that are to be supplied to the model for computing values at stages of the user product adoption funnel 210. These user data may include, for example, user industry (e.g., line of business), geographic location or locations (e.g., country, province, cities, and the like), size of user (e.g., number of employees, user total revenue, and the like), and other features like describing users. In addition, the historical transaction data 121 may store information about product usage rates, growth rates, and retention rates. These product usage data serve as labels for the training data. Accordingly, using a method such as the method shown in FIG. 4, the model trainer 123 trains a statistical model (e.g., a BTYD model, a gradient boosting model, or the like) to predict the labels (e.g., the usage, user growth, and retention) that will be exhibited by a user of a platform based on these input data. The statistical model may be initialized and then used to compute statistical predictions at 420. At 430, the model trainer 123 computes a loss based on the predictions made by the statistical model and the labels, where the loss represents an error or difference between the predictions and the labels. At 440, the model trainer 123 determines if training is complete, such as based on whether the loss is acceptably small. If so, then the resulting model is output. If training is not complete, then at 450 the model trainer 123 updates the parameters of the statistical model based on the computed loss (e.g., using gradient descent) and then proceeds with another iteration of the training process by computing new predictions using the updated statistical model at 420. The process continues until a satisfactory model is computed or a set number of iterations is reached or the model stops improving.

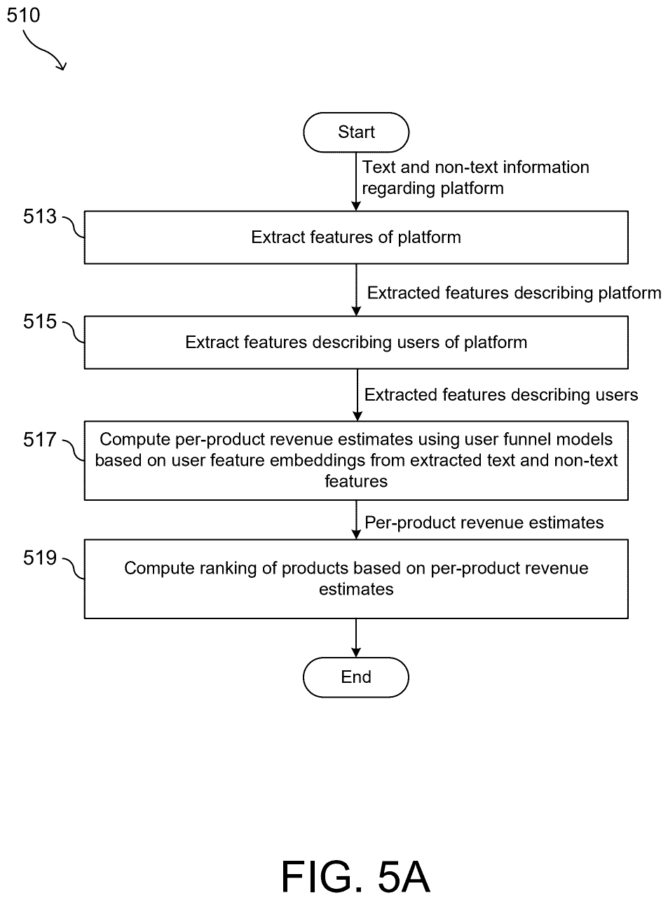

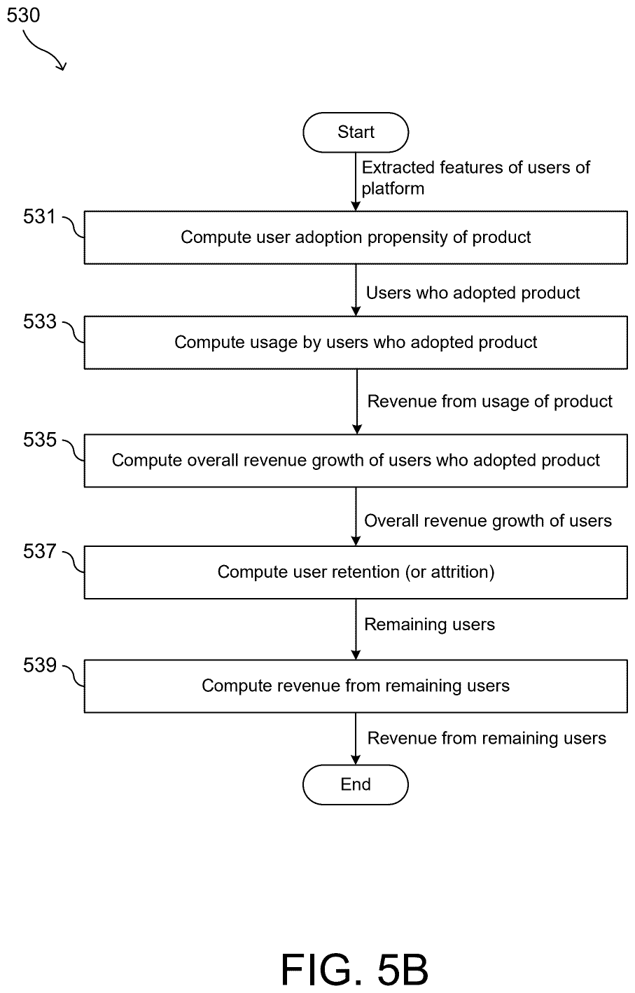

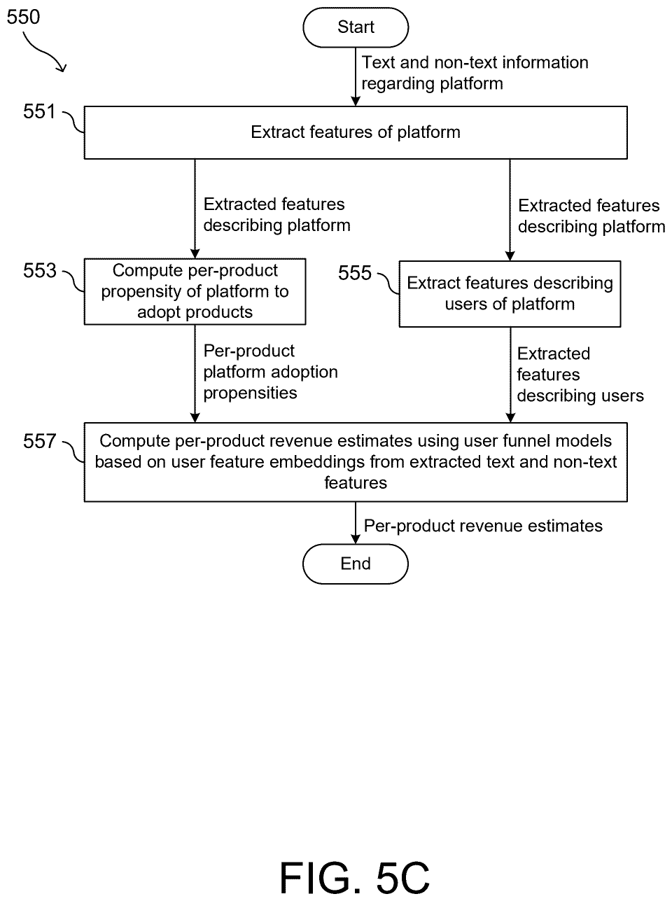

FIG. 5A is a flowchart of a method 510 for generating a ranking of products to be adopted by a platform using trained statistical models corresponding to different stages of the adoption funnel, according to one embodiment of the present disclosure. In the example shown in FIG. 5A, text and non-text information regarding a platform are provided as input to the method 510, which may be implemented using a computer system such as the computer system 800 shown and described with respect to FIG. 8. The text and non-text information of the platform may include information such as a text description of the platform (e.g., text description of the target market of users, such as types of user merchants that are targeted to use the platform). Examples of non-text information of the platform may include, for example, number of users, average revenue per user, distribution of revenue per user, industry or industries in which the users operate, average size of transactions between users and consumers, and the like.

At 513, the computer system extracts features of the platform from the text and non-text information. These features may be represented as feature vectors, such as vectors of numbers (e.g., tens to hundreds to thousands of values) which are a numerical embedding or representation of the various characteristics of the platform as described in the text and non-text information.

In some embodiments, at 515, the features of the platform (e.g., feature vectors) are used to compute features describing prospective users of the platform. This mapping may be performed using a trained statistical model that is trained based on portions of the historical transaction data 121 corresponding to descriptions of existing platforms 130 using services of the provider 100 and corresponding to descriptions of users 150 of those existing platforms 130. The descriptions (text and non-text) of these existing platforms and their users are converted to feature representations (e.g., corresponding feature vectors) and a machine learning model is trained to compute feature vectors representing the users of the platforms based on given input feature vectors representing the platforms. Accordingly, this trained machine learning model is used to compute or extract features describing users (or prospective users, because actual users may not exist in the case of a new platform) based on feature vectors describing the platform.

At 517, the computer system computes per-product revenue estimates using the user funnel models described above, such as by computing per-product adoption propensities, per-product usage and growth, and per-product retention rates, based on the user feature embeddings (the extracted features describing users).

FIG. 5B is a flowchart of a method 530 for computing per-product revenue estimates based on different stages of the user product adoption funnel 210, according to one embodiment of the present disclosure. The method 530 shown in FIG. 5B may be implemented using a computer system such as the computer system 800 shown and described with respect to FIG. 8.

At 531, the computer system computes a user product adoption propensity, such as by applying the method 330 shown in FIG. 3B and supplying extracted features (as represented by a feature vector) of one or more users of the platform to a first trained machine learning model (e.g., the propensity score predictor 319 shown in FIG. 3A).

At 533, the computer system computes a usage by users who adopted the product. As noted above, in some embodiments this is performed by supplying the extracted features (e.g., feature vector) to a second trained machine learning model, separate from the first machine learning model used to compute the user product adoption propensity. In some embodiments, this second trained machine learning model includes a buy-till-you-die (BTYD) model.

At 535, the computer system computes an overall revenue growth of users who adopt the product. In some embodiments, this computation is performed by supplying the extracted features using a third trained machine learning model, which is trained based on historical transaction data for existing users of the product (e.g., the growth of revenue before and after adopting the product among similar users, as represented by the feature vector).

At 537, the computer system computes a user retention (or attrition), which may be expressed as a rate or a probability that the user will still be a user of the platform (e.g., after a specific time period). In some embodiments, a fourth trained machine learning model is used to compute the retention rate of users, based on historical observations of the retention rate of users of products on platforms.

At 539, the computer system uses the computed user product adoption propensity, the usage, the overall revenue growth, and the user retention to compute an overall revenue from the remaining users (e.g., the users who adopted the product and did not leave the platform or the product).

Referring again to FIG. 5A, at 519, the computer system computes a ranking (e.g., a stack ranking) of products based on the estimated revenue growth for platform.

In some embodiments, the resulting ranking is presented via the user interface 127. A sales agent may use the rankings to identify products to be promoted to a particular platform. An operator of a platform may use the rankings to select products that are likely to increase overall revenue if adopted.

In some embodiments, the resulting rankings are used to generate, automatically, promotional materials for an operator of a platform. These promotional materials may include targeted email solicitations specifying the products that are recommended to the user (e.g., and a call to action to add those products to their platforms), targeted advertising or other promotions within user interfaces (e.g., in a web page displayed in a web browser) for interacting with the provider (e.g., a dashboard user interface).

Some aspects of embodiments of the present disclosure relate to predicting revenue growth of the provider 100 over time based on adoption of products. As noted above, the available products 110 are sold to users 150 via intermediary platforms 130, which share in the revenue earned from users 150. A provider 100 may be interested in computing an expected revenue growth over time, such as on a per-product basis or overall based on adoption of products by platforms 130 who resell the products to users 150.

FIG. 5C is a flowchart of a method 550 for computing an estimated revenue increase using trained statistical models corresponding to different stages of the adoption funnel, according to one embodiment of the present disclosure. In the below example, the estimated revenue increase is computed for a single platform, but embodiments of the present disclosure are not limited thereto and the estimates may be computed for each platform among multiple platforms, where an aggregated (e.g., sum) total estimated revenue increase across the multiple platforms can be reported by the computer system.

In the example shown in FIG. 5C, text and non-text information regarding a platform are provided as input to the method 550, which may be implemented using a computer system such as the computer system 800 shown and described with respect to FIG. 8. The text and non-text information of the platform may include information such as a text description of the platform (e.g., text description of the target market of users, such as types of user merchants that are targeted to use the platform). Examples of non-text information of the platform may include, for example, number of users, average revenue per user, distribution of revenue per user, industry or industries in which the users operate, average size of transactions between users and consumers, and the like.

At 551, the computer system extracts features of the platform from the text and non-text information. These features may be represented as feature vectors, such as vectors of numbers (e.g., tens to hundreds to thousands of values) which are a numerical embedding or representation of the various characteristics of the platform as described in the text and non-text information.

At 553, the computer system computes per-product propensities of a given platform to adopt the various available products 110. (Or for multiple platforms in the case of aggregating estimated revenue across these multiple platforms.)

In some embodiments, at 555, the features of the platform (e.g., feature vectors) are used to compute features describing prospective users of the platform. This mapping may be performed using a trained statistical model that is trained based on portions of the historical transaction data 121 corresponding to descriptions of existing platforms 130 using services of the provider 100 and corresponding to descriptions of users 150 of those existing platforms 130. The descriptions (text and non-text) of these existing platforms and their users are converted to feature representations (e.g., corresponding feature vectors) and a machine learning model is trained to compute feature vectors representing the users of the platforms based on given input feature vectors representing the platforms. Accordingly, this trained machine learning model is used to compute or extract features describing users (or prospective users, because actual users may not exist in the case of a new platform) based on feature vectors describing the platform.

At 557, the computer system computes per-product revenue estimates using the user funnel models described above, such as by applying the per-product platform adoption propensities, computing per-product user adoption propensities, per-product usage and growth, and per-product retention rates, based on the user feature embeddings (the extracted features describing users).

At 559, the computer system computes estimated revenue growths for the platform on a per-product basis.

In some embodiments, the method of FIG. 5C is also used to predict revenue impact of the promotion of products to platforms. For example, increasing promotion of products (e.g., through targeted advertising, directed marketing, promotional pricing, and the like) may increase the propensity of a platform and/or users of the platform to adopt products, thereby widening the funnel at corresponding stages and increasing revenue. Accordingly, the changes to platform adoption rates as computed at 553 and the changes to user adoption rates as computed at 557 may be adjusted based on promotion, thereby enabling the computer system to report estimated revenues in view of promotion of the product (e.g., advertising).

Therefore, aspects of embodiments of the present disclosure relate to estimating product distribution growth in a context where products are distributed through intermediaries or platforms. Estimates of revenue growth are computed, in some embodiments, using trained machine learning models that are trained to compute estimates of revenue growth in accordance with features describing platforms and, implicitly or implicitly, the users of those platforms (e.g., individual small businesses operating on the platforms). The machine learning models may correspond to different stages of a user (e.g., merchant) adoption funnel, representing the propensity of users to adopt products (e.g., based on alignment with target consumer markets served by those user merchants) and revenue growth of those users based on adoption of those products.

With reference to FIG. 6, an example embodiment of a high-level SaaS network architecture 600 is shown. A networked system 616 provides server-side functionality via a network 610 (e.g., the Internet or a WAN) to a client device 608. A web client 602 and a programmatic client, in the example form of a client application 604 (e.g., client software for accessing estimates of product growth revenue, such as a web browser for connecting to user interface 127 shown in FIG. 1), are hosted and execute on the client device 608. The networked system 616 includes one or more servers 622 (e.g., servers hosting services exposing remote procedure call APIs), which hosts a processing system 606 (such as the processing system described above according to various embodiments of the present disclosure supporting service for automatically processing accounting data) that provides a number of functions and services via a service oriented architecture (SOA) and that exposes services to the client application 604 that accesses the networked system 616 where the services may correspond to particular workflows. The client application 604 also provides a number of interfaces described herein, which can present an output in accordance with the methods described herein to a user of the client device 608.

The client device 608 enables a user to access and interact with the networked system 616 and, ultimately, the processing system 606. For instance, the user provides input (e.g., touch screen input or alphanumeric input) to the client device 608, and the input is communicated to the networked system 616 via the network 610. In this instance, the networked system 616, in response to receiving the input from the user, communicates information back to the client device 608 via the network 610 to be presented to the user.

An API server 618 and a web server 620 are coupled, and provide programmatic and web interfaces respectively, to the servers 622. For example, the API server 618 and the web server 620 may produce messages (e.g., RPC calls) in response to inputs received via the network, where the messages are supplied as input messages to workflows orchestrated by the processing system 606. The API server 618 and the web server 620 may also receive return values (return messages) from the processing system 606 and return results to calling parties (e.g., web clients 602 and client applications 604 running on client devices 608 and third-party applications 614) via the network 610. The servers 622 host the processing system 606, which includes components or applications in accordance with embodiments of the present disclosure as described above. The servers 622 are, in turn, shown to be coupled to one or more database servers 624 that facilitate access to information storage repositories (e.g., databases 626). In an example embodiment, the databases 626 includes storage devices that store information accessed and generated by the processing system 606, such as the historical transaction data 121 of FIG. 1 and other databases such as databases storing information associated with transactions processed by a business.

Additionally, a third-party application 614, executing on one or more third-party servers 621, is shown as having programmatic access to the networked system 616 via the programmatic interface provided by the API server 618. For example, the third-party application 614, using information retrieved from the networked system 616, may support one or more features or functions on a website hosted by a third-party. For example, the third-party application 614 may serve as a data source for retrieving, for example, the historical transaction data 121 and/or for retrieving text and non-text descriptions of platforms and/or users.

Turning now specifically to the applications hosted by the client device 608, the web client 602 may access the various systems (e.g., the processing system 606) via the web interface supported by the web server 620. Similarly, the client application 604 (e.g., an “app” such as a web browser app) may access the various services and functions provided by the processing system 606 via the programmatic interface provided by the API server 618. The client application 604 may be, for example, an “app” executing on the client device 608, such as an iOS or Android OS application to enable a user to access and input data on the networked system 616 in an offline manner and to perform batch-mode communications between the client application 604 and the networked system 616.

Further, while the network architecture 600 shown in FIG. 6 employs a client-server architecture, the present disclosure is not limited to such an architecture, and could equally well find application in a distributed, or peer-to-peer, architecture system, for example.

FIG. 7 is a block diagram illustrating an example software architecture 706, which may be used in conjunction with various hardware architectures herein described. FIG. 7 is a non-limiting example of a software architecture 706, and it will be appreciated that many other architectures may be implemented to facilitate the functionality described herein. The software architecture 706 may execute on hardware such as a machine 800 of FIG. 8 that includes, among other things, processors 804, memory/storage 806, and input/output (I/O) components 818. A representative hardware layer 752 is illustrated and can represent, for example, the machine 800 of FIG. 8. The representative hardware layer 752 includes a processor 754 having associated executable instructions 704. The executable instructions 704 represent the executable instructions of the software architecture 706, including implementation of the methods, components, and so forth described herein. The hardware layer 752 also includes non-transitory memory and/or storage modules as memory/storage 756, which also have the executable instructions 704. The hardware layer 752 may also include other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716 (such as the services of the product revenue estimator 120), and a presentation layer 714. Operationally, the applications 716 and/or other components within the layers may invoke API calls 708 through the software stack and receive a response as messages 712 in response to the API calls 708. The layers illustrated are representative in nature, and not all software architectures have all layers. For example, some mobile or special-purpose operating systems may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 720 may also include a wide variety of other libraries 748 to provide many other APIs to the applications 716 and other software components/modules.

The frameworks/middleware 718 provide a higher-level common infrastructure that may be used by the applications 716 and/or other software components/modules. For example, the frameworks/middleware 718 may provide high-level resource management functions, web application frameworks, application runtimes 742 (e.g., a Java virtual machine or JVM), and so forth. The frameworks/middleware 718 may provide a broad spectrum of other APIs that may be utilized by the applications 716 and/or other software components/modules, some of which may be specific to a particular operating system or platform.

The applications 716 include built-in applications 738 and/or third-party applications 740. The applications 716 may use built-in operating system functions (e.g., kernel 722, services 724, and/or drivers 726), libraries 720, and frameworks/middleware 718 to create user interfaces to interact with users of the system. Alternatively, or additionally, in some systems, interactions with a user may occur through a presentation layer, such as the presentation layer 714. In these systems, the application/component “logic” can be separated from the aspects of the application/component that interact with a user.

Some software architectures use virtual machines. In the example of FIG. 7, this is illustrated by a virtual machine 710. The virtual machine 710 creates a software environment where applications/components can execute as if they were executing on a hardware machine (such as the machine 800 of FIG. 8, for example). The virtual machine 710 is hosted by a host operating system (e.g., the operating system 702 in FIG. 7) and typically, although not always, has a virtual machine monitor 760 (or hypervisor), which manages the operation of the virtual machine 710 as well as the interface with the host operating system (e.g., the operating system 702). A software architecture executes within the virtual machine 710 such as an operating system (OS) 736, libraries 734, frameworks 732, applications 730, and/or a presentation layer 728. These layers of software architecture executing within the virtual machine 710 can be the same as corresponding layers previously described or may be different.

Some software architectures use containers 770 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 770 is similar to a virtual machine in that it includes a software architecture including libraries 734, frameworks 732, applications 730, and/or a presentation layer 728, but omits an operating system and, instead, communicates with the underlying host operating system 702.

FIG. 8 is a block diagram illustrating components of a machine 800, according to some example embodiments, able to read instructions from a non-transitory machine-readable medium (e.g., a computer-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 810, sequentially or in parallel or concurrently, that specify actions to be taken by the machine 800. Further, while only a single machine 800 is illustrated, the term “machine” or “processing circuit” shall also be taken to include a collection of machines that individually or jointly execute the instructions 810 to perform any one or more of the methodologies discussed herein.

The machine 800 may include processors 804 (including processors 808 and 812), memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor's cache memory), or any suitable combination thereof, during execution thereof by the machine 800. Accordingly, the memory 814, the storage unit 816, and the memory of the processors 804 are examples of machine-readable media.

The I/O components 818 may include a wide variety of components to receive input, provide output, produce output, transmit information, exchange information, capture measurements, and so on. The specific I/O components 818 that are included in a particular machine will depend on the type of machine. For example, portable machines such as mobile phones may include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion, and the grouping is in no way limiting. In various example embodiments, the I/O components 818 may include output components 826 and input components 828. The output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 818 may include biometric components 830, motion components 834, environment components 836, or position components 838, among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via a coupling 824 and a coupling 822, respectively. For example, the communication components 840 may include a network interface component or other suitable device to interface with the network 832. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method includes: computing a feature vector representing a user of a platform, the platform providing access to one or more products among a plurality of available products from a provider, the one or more products of the platform facilitating interactions between the user and consumers; and computing an estimated revenue based on the platform adopting a product of the plurality of available products, based on a plurality of usage factors, including: computing a user adoption propensity of the product based on supplying the feature vector to a first trained machine learning model; computing a usage of the product by the user based on supplying the feature vector to a second trained machine learning model; computing an overall revenue growth of the user from the one or more products of the platform due to adoption of the product by the user based on supplying the feature vector to a third trained machine learning model; and computing a retention of the user based on supplying the feature vector to a fourth trained machine learning model.

The first trained machine learning model may be trained based on training data from historical interactions between a plurality of existing users and a plurality of existing platforms providing access to corresponding selections of the available products of the provider.

The user may be a prospective user of the platform, and the second trained machine learning model may be a model to compute expected revenue for the prospective user.

The feature vector may be computed based on one or more selected from the group including: visits product page on a website of the provider; total revenue of the user; time on platform of the user; and industry of the user.

The platform may be associated with a first industry, the method may further include computing a second estimated revenue based on a second platform adopting the product of the plurality of available products, and the second platform may be associated with a second industry different from the first industry.

The method may further include: computing a plurality of feature vectors representing a plurality of users of the platform; and computing an estimated overall revenue to the platform over the plurality of users of the platform based on the plurality of feature vectors.

The method may further include: computing a plurality of estimated overall revenues to the platform over the plurality of available products based on a plurality of user product adoption funnels corresponding to the plurality of available products; ranking the plurality of available products based on corresponding estimated overall revenues to the platform; and displaying the ranking of the plurality of available products on a user interface.

According to one embodiment of the present disclosure, a system includes: a processor; and memory storing instructions that, when executed by the processor, cause the processor to: compute a plurality of feature vectors representing a plurality of users of a platform, the platform providing access to one or more products among a plurality of available products from a provider, the one or more products of the platform facilitating interactions between the user and consumers; and compute a plurality of estimated revenues based on the platform adopting a corresponding product of the plurality of available products based on a plurality of usage factors including: computing a user adoption propensity of the product based on supplying the feature vector to a first trained machine learning model; computing a usage of the product by the plurality of users based on supplying the feature vector to a second trained machine learning model; computing an overall revenue growth of the plurality of users from the one or more products of the platform due to adoption of the corresponding product by the plurality of users based on supplying the feature vector to a third trained machine learning model; computing a retention of the plurality of users based on supplying the feature vector to a fourth trained machine learning model; and computing an overall estimated revenue associated with the corresponding product based on the user adoption propensity, the usage, the overall revenue growth, and the retention of the plurality of users.

The memory may further store instructions that, when executed by the processor, cause the processor to: generate a ranking of the plurality of available products based on corresponding overall estimated revenue for each of the plurality of available products.

The first trained machine learning model may be trained based on training data from historical interactions between a plurality of existing users and a plurality of existing platforms providing access to corresponding selections of the available products of the provider.

The plurality of users may include a prospective user of the platform, and the second trained machine learning model may be a model to compute expected revenue for the prospective user.

A feature vector of the plurality of feature vectors may be computed based on one or more selected from the group including: visits product page on a website of the provider; total revenue of a user of the plurality of users; time on platform of the user; and industry of the user.

The instructions to compute a plurality of estimated revenues based on the platform adopting the corresponding product of the plurality of available products may further include instructions that, when executed by the processor, cause the processor to compute a platform adoption propensity for the product, representing a likelihood that the platform will adopt the product.

According to one embodiment of the present disclosure, a non-transitory computer-readable medium storing instructions that, when executed by a processor, cause the processor to: compute a feature vector representing a platform, the platform providing access to one or more products among a plurality of available products from a provider, the one or more products of the platform facilitating interactions between a plurality of users of the platform and consumers; and compute a ranking of products among the plurality of available products from the provider in accordance with a plurality of usage factors including: computing a user adoption propensity of the product, representing a likelihood that the plurality of users of the platform will adopt the product, based on supplying the feature vector to a first trained machine learning model; computing a usage of the product by the plurality of users, representing expected revenues from the use of the product by the plurality of users, based on supplying the feature vector to a second trained machine learning model; computing an overall revenue growth of the plurality of users from the one or more products of the platform due to adoption of the product by the plurality of users based on supplying the feature vector to a third trained machine learning model; and computing a plurality of retentions of the plurality of users, representing a likelihood that the plurality of users remain connected to the platform, based on supplying the feature vector to a fourth trained machine learning model.

The feature vector may be computed based on text information and non-text information.

The first trained machine learning model may be trained based on training data from historical interactions between a plurality of existing users and a plurality of existing platforms providing access to corresponding selections of the available products of the provider.

The plurality of users may include a prospective user of the platform, and the second trained machine learning model may be a model to compute expected revenue for the prospective user.

The feature vector may be computed based on one or more selected from the group including: visits product page on a website of the provider; total revenue of the plurality of users; time on platform of the plurality of users; and industry of the users.

The non-transitory computer-readable medium may further store instructions that, when executed by the processor, cause the processor to generate a report of the ranking of the products.

The non-transitory computer-readable medium may further store instructions that, when executed by the processor, cause the processor to transmit a promotion of a product to the platform, the product being selected from the available products based on the ranking of the products.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
computing a feature vector representing a user of a platform, the platform providing access to one or more products among a plurality of available products from a provider, the one or more products of the platform facilitating interactions between the user and consumers; and
computing an estimated revenue based on the platform adopting a product of the plurality of available products, based on a plurality of usage factors, comprising:
computing a user adoption propensity of the product based on supplying the feature vector to a first trained machine learning model;
computing a usage of the product by the user based on supplying the feature vector to a second trained machine learning model;
computing an overall revenue growth of the user from the one or more products of the platform due to adoption of the product by the user based on supplying the feature vector to a third trained machine learning model; and
computing a retention of the user based on supplying the feature vector to a fourth trained machine learning model.

2. The method of claim 1, wherein the first trained machine learning model is trained based on training data from historical interactions between a plurality of existing users and a plurality of existing platforms providing access to corresponding selections of the available products of the provider.

3. The method of claim 1, wherein the user is a prospective user of the platform, and
wherein the second trained machine learning model is a model to compute expected revenue for the prospective user.

4. The method of claim 1, wherein the feature vector is computed based on one or more selected from the group comprising:
visits product page on a website of the provider;
total revenue of the user;
time on platform of the user; and
industry of the user.

5. The method of claim 1, wherein the platform is associated with a first industry,
wherein the method further comprises computing a second estimated revenue based on a second platform adopting the product of the plurality of available products, and
wherein the second platform is associated with a second industry different from the first industry.

6. The method of claim 1, further comprising:
computing a plurality of feature vectors representing a plurality of users of the platform; and
computing an estimated overall revenue to the platform over the plurality of users of the platform based on the plurality of feature vectors.

7. The method of claim 1, further comprising:
computing a plurality of estimated overall revenues to the platform over the plurality of available products based on a plurality of user product adoption funnels corresponding to the plurality of available products;
ranking the plurality of available products based on corresponding estimated overall revenues to the platform; and
displaying the ranking of the plurality of available products on a user interface.

8. A system comprising:
a processor; and
memory storing instructions that, when executed by the processor, cause the processor to:
compute a plurality of feature vectors representing a plurality of users of a platform, the platform providing access to one or more products among a plurality of available products from a provider, the one or more products of the platform facilitating interactions between the user and consumers; and
compute a plurality of estimated revenues based on the platform adopting a corresponding product of the plurality of available products based on a plurality of usage factors comprising:
computing a user adoption propensity of the product based on supplying the feature vector to a first trained machine learning model;
computing a usage of the product by the plurality of users based on supplying the feature vector to a second trained machine learning model;
computing an overall revenue growth of the plurality of users from the one or more products of the platform due to adoption of the corresponding product by the plurality of users based on supplying the feature vector to a third trained machine learning model;
computing a retention of the plurality of users based on supplying the feature vector to a fourth trained machine learning model; and
computing an overall estimated revenue associated with the corresponding product based on the user adoption propensity, the usage, the overall revenue growth, and the retention of the plurality of users.

9. The system of claim 8, wherein the memory further stores instructions that, when executed by the processor, cause the processor to:
generate a ranking of the plurality of available products based on corresponding overall estimated revenue for each of the plurality of available products.

10. The system of claim 8, wherein the first trained machine learning model is trained based on training data from historical interactions between a plurality of existing users and a plurality of existing platforms providing access to corresponding selections of the available products of the provider.

11. The system of claim 8, wherein the plurality of users comprises a prospective user of the platform, and
wherein the second trained machine learning model is a model to compute expected revenue for the prospective user.

12. The system of claim 8, wherein a feature vector of the plurality of feature vectors is computed based on one or more selected from the group comprising:
visits product page on a website of the provider;
total revenue of a user of the plurality of users;
time on platform of the user; and
industry of the user.

13. The system of claim 8, wherein the instructions to compute a plurality of estimated revenues based on the platform adopting the corresponding product of the plurality of available products further comprise instructions that, when executed by the processor, cause the processor to compute a platform adoption propensity for the product, representing a likelihood that the platform will adopt the product.

14. A non-transitory computer-readable medium storing instructions that, when executed by a processor, cause the processor to:
compute a feature vector representing a platform, the platform providing access to one or more products among a plurality of available products from a provider, the one or more products of the platform facilitating interactions between a plurality of users of the platform and consumers; and
compute a ranking of products among the plurality of available products from the provider in accordance with a plurality of usage factors comprising:
computing a user adoption propensity of the product, representing a likelihood that the plurality of users of the platform will adopt the product, based on supplying the feature vector to a first trained machine learning model;
computing a usage of the product by the plurality of users, representing expected revenues from the use of the product by the plurality of users, based on supplying the feature vector to a second trained machine learning model;
computing an overall revenue growth of the plurality of users from the one or more products of the platform due to adoption of the product by the plurality of users based on supplying the feature vector to a third trained machine learning model; and
computing a plurality of retentions of the plurality of users, representing a likelihood that the plurality of users remain connected to the platform, based on supplying the feature vector to a fourth trained machine learning model.

15. The non-transitory computer-readable medium of claim 14, wherein the feature vector is computed based on text information and non-text information.

16. The non-transitory computer-readable medium of claim 14, wherein the first trained machine learning model is trained based on training data from historical interactions between a plurality of existing users and a plurality of existing platforms providing access to corresponding selections of the available products of the provider.

17. The non-transitory computer-readable medium of claim 14, wherein the plurality of users comprises a prospective user of the platform, and
wherein the second trained machine learning model is a model to compute expected revenue for the prospective user.

18. The non-transitory computer-readable medium of claim 14, wherein the feature vector is computed based on one or more selected from the group comprising:
visits product page on a website of the provider;
total revenue of the plurality of users;
time on platform of the plurality of users; and
industry of the users.

19. The non-transitory computer-readable medium of claim 14, further storing instructions that, when executed by the processor, cause the processor to generate a report of the ranking of the products.

20. The non-transitory computer-readable medium of claim 14, further storing instructions that, when executed by the processor, cause the processor to transmit a promotion of a product to the platform, the product being selected from the available products based on the ranking of the products.
